(19) United States
(12) Patent Application Publication
(10) Pub. No.: US 2017/0092223 A1
(43) Pub. Date: Mar. 30, 2017

(54) THREE-DIMENSIONAL SIMULATION SYSTEM FOR GENERATING A VIRTUAL ENVIRONMENT INVOLVING A PLURALITY OF USERS AND ASSOCIATED METHOD

(71) Applicant: DASSAULT AVIATION, PARIS (FR)

(72) Inventors: Igor FAIN, BEZONS (FR); Patrice KURDIJIAN, LA CELLE SAINT CLOUD (FR)

(21) Appl. No.: 15/273,587

(22) Filed: Sep. 22, 2016

(30) Foreign Application Priority Data
Sep. 24, 2015 (FR) FR 15 01977

(51) Int. Cl. G09G 5/00; G09B 9/30; G06T 17/00; G06T 7/00; G06T 19/00; G06F 3/01

(52) U.S. Cl. CPC G09G 5/003; G06T 19/006; G06F 3/013; G06T 17/00; G06F 3/012; G06T 7/004; G06T 7/0081; G09B 9/301

(57) ABSTRACT

A three-dimensional simulation system for generating a virtual environment involving a plurality of users and associated method are provided. The system includes a first sensor detecting a viewing direction of a first user, a computing unit configured to create a three-dimensional simulation of the virtual environment, based on data received from the at least one first sensor; for at least one second user, an immersive retrieval assembly for the virtual three-dimensional simulation created by the computing unit. The system includes, for the first user, a second sensor detecting the position of part of an actual limb of the first user. The computing unit is configured to create, in the virtual three-dimensional simulation, an avatar of the first user, comprising a virtual head and a virtual limb, reconstituted and oriented relative to one another based on data from the first sensor and the second sensor.

This claims the benefit of French Patent Application FR 15 01977, filed Sep. 24, 2015 and hereby incorporated by reference herein.

The present invention relates to a three-dimensional simulation system for generating a virtual environment involving a plurality of users, comprising:
for at least one first user, a first sensor detecting a viewing direction of the first user,
a computing unit able to create a three-dimensional simulation of the virtual environment, based on data received from the or each first detection sensor;
for at least one second user, an immersive retrieval assembly for the virtual three-dimensional simulation created by the computing unit, able to immerse the or each second user in the virtual three-dimensional simulation.

Such a system is in particular intended to be used to organize technical training for several users in a same virtual environment.

In particular, the system according to embodiments of the invention is suitable for grouping users together in a virtual environment reproducing part of an aircraft, in particular to learn and repeat maintenance and/or usage procedures for the aircraft.

### BACKGROUND

These procedures generally require carrying out successive operations on various pieces of equipment following a predetermined sequence with defined gestures.

Generally, training of this type is conducted in a classroom, using two-dimensional media projected on screens, such as presentations comprising images.

Such presentations are not very representative of the actual environment within an aircraft. They make it possible to acquire theoretical knowledge of the procedure to be carried out, but do not provide much practical experience.

Other training sessions are conducted directly on an aircraft or on a model of the aircraft, which makes it possible to grasp the procedure to be carried out more concretely. During these training sessions, the number of participants simultaneously able to view the procedure to be carried out must often be limited, in particular if the environment is a confined space, for example in the technical compartment of an aircraft.

Furthermore, these training sessions require immobilizing an aircraft or reproducing a representative model of the aircraft, which is costly and impractical.

Furthermore, all of the participants must be present at the same time for the training, which may be expensive if the participants come from different sites.

It is also known to immerse a single user in a virtual three-dimensional environment, for example by equipping him with a helmet able to retrieve a virtual three-dimensional model. The user perceives the virtual environment, but not necessarily other users, which causes the training not to be very interactive.

### SUMMARY OF THE INVENTION

One aim of the invention is to provide a three-dimensional simulation system that allows an inexpensive and practical way of offering a highly interactive medium for users to interact with one another in an environment of a complex platform, for example to train users on the maintenance and/or use of the complex platform.

To that end, the invention provides a system of the aforementioned type, characterized in that the system comprises, for the or each first user, a second sensor detecting the position of part of an actual limb of the first user, the computing unit being able to create, in the virtual three-dimensional simulation, an avatar of the or each first user, comprising at least one virtual head and at least one virtual limb, reconstituted and oriented relative to one another based on data from the first sensor and the second sensor.

The system according to the invention may comprise one or more of the following features, considered alone or according to any technically possible combination:
the limb and the virtual limb are arms of the user and the avatar, respectively;
the part of the user's limb detected by the second sensor comprises the first user's hand;
the computing unit is able to determine the position of the first region of the virtual limb, based on data received from the first detection sensor, and is able to determine the position of a second region of the virtual limb from data received from the second detection sensor;
the computing unit is able to determine the position of the first region of the virtual limb after having determined the position of the second region of the virtual limb;
the computing unit is able to create a representation of a virtual shoulder of the first user, rotatable around a vertical axis jointly with the virtual head of the first user, the first region of the virtual limb extending from the end of the virtual shoulder;
it comprises, for a plurality of first users, a first sensor for detecting a viewing direction of the user, and a second sensor for detecting the position of part of a limb of the user,
the computing unit being able to create, in the virtual three-dimensional simulation, an avatar of each first user, comprising at least one virtual head and at least one virtual limb, reconstituted and oriented relative to one another based on data from the first sensor and the second sensor of the first user,
the or each retrieval assembly being able to selectively show the avatar of one or several first users in the virtual three-dimensional simulation;
the computing unit is able to place the avatars of a plurality of first users in a same given location in the virtual three-dimensional simulation, the or each retrieval assembly being able to selectively show the avatar of a single first user in the given location;
it comprises, for the or each first user, an immersive retrieval assembly for the virtual three-dimensional simulation created by the unit able to immerse the or each first user in the virtual three-dimensional simulation;
the retrieval assembly is able to be supported by the head of the first user, the first sensor and/or the second sensor being mounted on the retrieval assembly;
in a given predefined position of the part of a limb of the user detected by the second sensor, the computing unit is able to display at least one information and/or selection window in the virtual three-dimensional simulation visible by the or each first user and/or by the or each second user;
the computing unit is able to determine whether the position of the part of the real limb of the first user detected by the second sensor is physiologically possible and to conceal the display of the virtual limb of the avatar of the first user if the position of the part of the real limb of the first user detected by the second sensor is not physiologically possible;
it comprises, for the or each first user, a position sensor, able to provide the computing unit with geographical positioning data for the first user.

The invention also provides a method for developing a virtual three-dimensional simulation bringing several users together, including the following steps:
providing a system as described above;
activating the first sensor and the second sensor and transmitting data received from the first sensor and the second sensor to the computing unit,
generating a virtual three-dimensional simulation of an avatar of the or each first user, comprising at least one virtual head and at least one virtual limb, reconstituted and oriented relative to one another based on data from the first sensor and the second sensor.

The system according to the invention may comprise one or more of the following features, considered alone or according to any technically possible combination:
the generation of the virtual three-dimensional simulation comprises loading a model representative of the platform, and the virtual three-dimensional representation of the virtual environment of a region of the platform, the or each first user moving in the aircraft environment to perform at least one simulated maintenance and/or usage operation of the platform.

### BRIEF SUMMARY OF THE DRAWINGS

The invention will be better understood upon reading the following description, provided solely as an example and done in reference to the appended drawings, in which:

FIG. 1 is a diagrammatic view of a first three-dimensional simulation system according to an embodiment of the invention;

FIG. 2 is a view of the virtual environment created by the simulation system, comprising a plurality of avatars representative of several users;

FIGS. 3 and 4 are enlarged views illustrating the definition of an avatar;

FIG. 5 is a view illustrating a step for activating a selection menu within the virtual three-dimensional simulation;

FIG. 6 is a view of a selection indicator for a zone or an object in the virtual three-dimensional simulation;

FIG. 7 is a detailed view of a selection menu;

FIG. 8 is a view illustrating the selection of a region of an aircraft in the virtual three-dimensional simulation.

### DETAILED DESCRIPTION

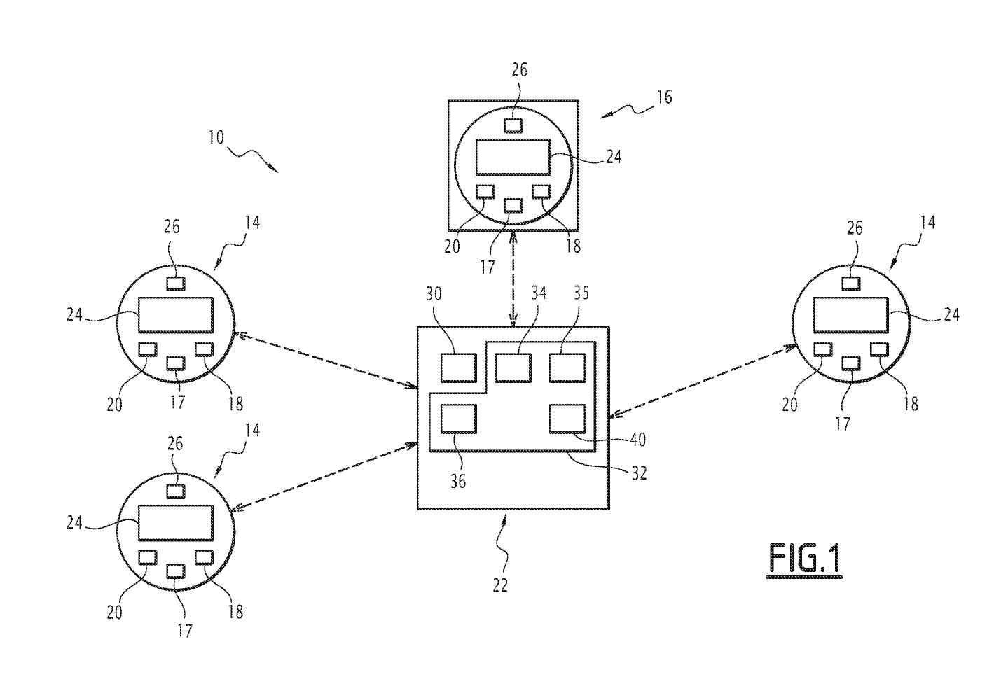

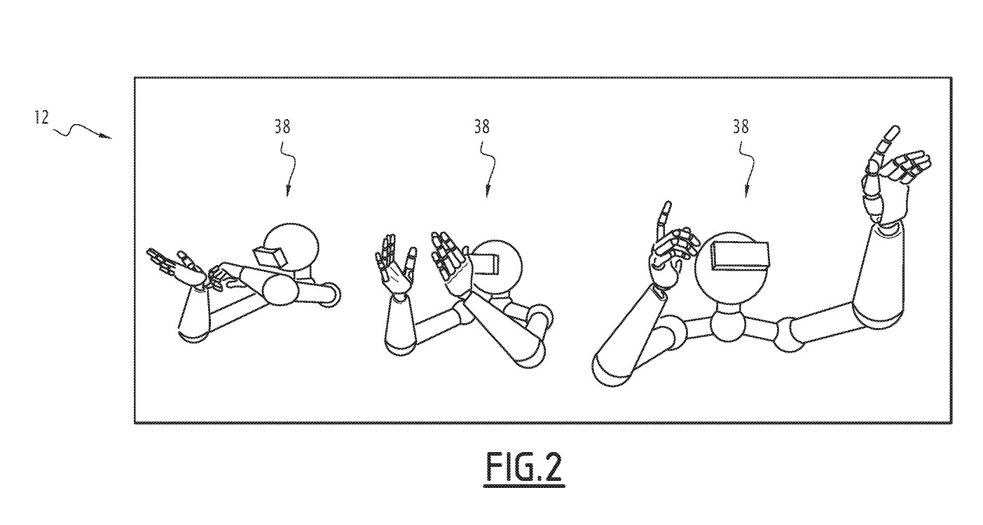

A first three-dimensional simulation system 10 according to an embodiment of the invention, able to generate a virtual environment 12, shown in FIG. 2, involving a plurality of users 14, 16 is illustrated in FIG. 1.

The system 10 is designed to be implemented in particular to simulate a maintenance and/or usage operation of a platform, in particular an aircraft, for example as part of a training program.

In this example, at least one first user 14 is able to receive and reproduce information relative to the maintenance and/or usage operation, in particular the steps of a maintenance and/or usage procedure. At least one second user 16 is a trainer distributing the information to each first user 14 and verifying the proper reproduction of the information.

The maintenance and/or usage operations for example include steps for assembling/disassembling equipment of the platform, or steps for testing and/or activating equipment of the platform.

In this example, the system 10 comprises, for each user 14, 16, a sensor 17 for detecting the position of the user, a first sensor 18 for detecting the viewing direction of the user 14, 16, and a second sensor 20 for detecting the position of part of a limb of the user 14, 16.

The system 10 further includes at least one computer in the form of a computing and synchronization unit 22, able to receive and synchronize data from each sensor 17, 18, 20 and to create a virtual three-dimensional simulation bringing the users 14, 16 together in the virtual environment 12, based on data from the sensors 17, 18, 20 and based on a three-dimensional model representative of the virtual environment 12. The three-dimensional model is for example a model of at least one zone of the platform.

The system 10 further includes, for each user 14, 16, an immersive retriever in the form of a retrieval assembly 24 for retrieving the virtual three-dimensional simulation created by the computing unit 22 from the point of view of the user 14, 16, to immerse each user 14, 16 in the virtual environment 12.

The retrieval assembly 24 is for example a virtual reality helmet. It is supported by the head of the user 14, 16 with a fixed orientation relative to the user's head. It generally includes a three-dimensional display system, arranged opposite the user's eyes, in particular a screen and/or glasses.

The retrieval assembly 24 is for example a helmet of the Oculus Rift DK2 type.

The position sensor 17 advantageously includes at least one element fastened on the retrieval assembly 24.

The position sensor 17 is for example a sensor comprising at least one light source, in particular a light-emitting diode, fastened on the retrieval assembly and an optical detector, for example infrared, arranged opposite the user to detect the light source.

Alternatively, the position sensor 17 is an accelerometer gyroscope, fastened on the retrieval assembly 24, the data of which is integrated to provide the user's position at each moment.

The position sensor 17 is able to provide geographical positioning data for the user, in particular to determine the overall movements of the head of the user 14, 16 relative to a centralized reference system shared by all of the users 14, 16.

The first detection sensor 18 is able to detect the viewing direction of the user 14, 16.

The first sensor 18 advantageously includes at least one element fastened on the retrieval assembly 24 to be jointly movable with the head of the user 14, 16. It is able to follow the viewing direction of the user along at least one vertical axis and at least one horizontal axis, preferably along at least three axes.

It is for example formed by an accelerometer gyroscope that may be identical, if applicable, to the gyroscope of the position sensor 17.

Alternatively, the first sensor 18 includes a light source supported by the retrieval assembly 24 and at least one camera, preferably several cameras for detecting the light source, the or each camera being fastened opposite the user, and being able to be shared with the position sensor 17, if applicable.

The first sensor 18 is able to produce data in a reference system specific to each user 14, 16 that is next transposed into the centralized reference system, using data from the position sensor 17.

The second sensor 20 is a sensor for detecting at least part of an actual limb of the user 14, 16. In particular, the user's limb is an arm, and the second sensor 20 is able to detect the position and orientation of the hand and at least one section of the forearm of the user 14, 16.

Preferably, the second sensor 20 is able to detect the position and orientation of both hands and the associated forearms of the user 14, 16.

The second sensor 20 is for example a movement sensor, advantageously working by infrared detection. The sensor is for example of the “Leap Motion” type.

Alternatively, the second sensor 20 is a camera working in the visible domain, associated with shape recognition software.

Advantageously, the second sensor 20 is also fastened on the retrieval assembly 24 to be jointly movable with the head of the user, while minimizing bother for the user.

The detection field of the sensor 20 extends opposite the user 14, 16, to maximize the likelihood of detecting the part of the limb of the user 14, 16 at each moment.

The second sensor 20 is able to produce data in a reference system specific to the sensor 20 that is next transposed into the reference system of the first sensor 18, then into the centralized reference system based on the position and orientation known from the second sensor on the retrieval assembly 24, and data from the position sensor 17 and the first sensor 18.

The data created by the first sensor 18 and the second sensor 20 is able to be transmitted in real time to the computing unit 22, at a frequency for example comprised between 60 Hz and 120 Hz.

Preferably, the retrieval assembly 24 is provided with a data transmission system 26 allowing two-way communication between the computing unit 22 and the retrieval assembled 24 via a transmission means, for example including a USB cable, to send the data from the sensors 17, 18, 20, and to receive, from the computing unit 22, the data necessary to immerse the user 14, 16 in the virtual three-dimensional simulation created by the computing unit 22.

The computing unit 22 includes at least one processor 30, and at least one memory 32 containing software applications able to be executed by the processor 30.

The memory 32 in particular contains an application 34 for loading a three-dimensional model representative of the virtual environment 12 in which the users 14, 16 are intended to be brought together, an application 35 for generating the virtual environment 12 based on the loaded three-dimensional model and, an application 36 for creating and positioning, for each user 14, 16, an animated avatar 38 in the virtual environment 12.

The memory 32 further contains a control and selective retrieval application 40 for the virtual environment 12 and avatar(s) 38 of each user 14, 16.

The loading application 34 is able to recover, in computerized form, a three-dimensional model file representative of the virtual environment 12 in which the users 14, 16 will be immersed.

The three-dimensional model is for example a model representative of a platform, in particular an aircraft as a whole, or part of the platform. The three-dimensional model for example includes relative positioning and shape data for a frame bearing components and each of the components mounted on the frame. It in particular includes data for assigning each component to a functional system (for example, a serial number for each component).

The model is generally organized within a computer file, in the form of a tree structure of models from a computer-assisted design program, this tree structure for example being organized by system type (structure, fastening, equipment).

The generating application 35 is able to use the data from the three-dimensional model to create a virtual three-dimensional representation of the virtual environment 12.

The application 36 for creating and positioning animated avatars 38 is able to analyze the position of each user 14, 16 in the virtual environment 12 based on positioning data from the position sensor 17, and viewing direction data, received from the first sensor 18.

The creation and positioning application 36 is able to create, for each user 14, 16, an animated avatar 38 representative of the attitude and positioning of at least one limb of the user, in particular at least one arm of the user, and to place each avatar 38 in the virtual environment 12.

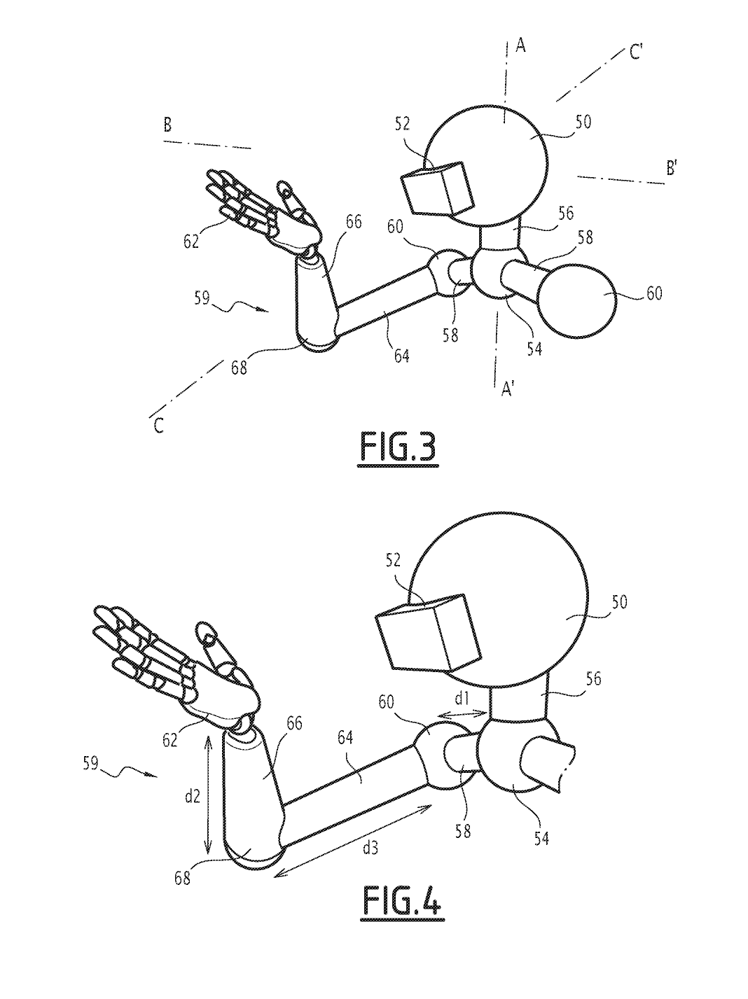

In the example illustrated by FIG. 3 and FIG. 4, the avatar 38 comprises a virtual head 50, movable based on the movements of the head of the user 14, 16, measured by the first sensor 18, a virtual trunk 54 connected to the virtual head 50 by a virtual neck 56 and virtual shoulders 58, the virtual trunk 54 and the virtual shoulders 58 being rotatable jointly with the virtual head 50.

The avatar 38 further comprises two virtual limbs 59, each virtual limb 59 being movable based on the movement and orientation of the corresponding limb part of the user detected by the second sensor 20. Each virtual limb here comprises a virtual hand 62, a first region 64 and a second region 66 connected to one another by a virtual neck 68.

To create and position the avatar 38, the application 36 comprises a positioning module for the virtual head 50 of the avatar 38, based on data received from the position sensor 17 and the first sensor 18, a positioning module for the virtual trunk 54 and virtual shoulders 58 of the avatar 38, based on positioning data for the virtual head 50, and a positioning module for virtual limbs 59 of the user 14, 16 in the virtual environment 12, in particular based on data from the second sensor 20.

For each user 14, 16, the positioning module of the virtual head 50 is able to use the data from the position sensor 17 to situate the virtual head 50 of the avatar 38 in the virtual environment 12.

The data from the position sensor 17 is recalibrated in a reference system shared by all of the users 14, 16 in the virtual environment 12.

In a first operating mode, the avatars 38 of the users 14, 16 are positioned in separate locations from one another, within the virtual environment 12, as shown in FIG. 2.

In another operating mode, the avatars 38 of the users 14, 16 are positioned overlapping one another, in particular if the virtual environment 12 is confined. In this case, as will be seen below, each user 14, 16 is not able to see all of the avatars 38 present in the confined virtual environment 12.

The positioning module of the virtual head 50 is able to process data from the first sensor 18 to create, in real time, orientation data of the virtual head 50 of the avatar 38 corresponding to the viewing direction measured from the first sensor 18.

The virtual head of the avatar 38 here has a substantially spherical shape. It includes a marker representative of the viewing direction, in particular a box 52 illustrating the position of the user's eyes, and of the retrieval assembly 24 placed over the eyes.

The viewing direction of the avatar 38 can be oriented around at least one vertical axis A-A′ and one vertical axis B-B′, and advantageously along a second horizontal axis C-C′.

The avatar 38 is thus not limited in rotation and can move its viewing direction by more than 90° on each side of its base viewing direction.

The module for determining the positioning of the virtual trunk 54 and shoulders 58 is able to lock the position of the virtual trunk 54 in real time, also shown by a sphere on the avatar 38 at a predetermined distance from the head 50. This predetermined distance corresponds to the height of the virtual neck 56 of the avatar 38 shown by a cylinder oriented vertically.

The virtual neck 56 is placed vertically at the level of the vertical pivot point of the virtual head 50 around the vertical axis A-A′.

The positioning module of the virtual trunk 54 and virtual shoulders 58 is further able to fix the angular orientation of the virtual shoulders 58 by keeping them in a vertical plane, with a fixed angle relative to the horizontal, on either side of the vertical axis A-A′ of the neck 56.

It is able to pivot the plane containing the virtual shoulders 58 jointly with the virtual head 50 around the vertical axis A-A′, to continuously follow the rotation of the virtual head 50 around the vertical axis A-A′.

Thus, the virtual shoulders 58 of the avatar 38 remain fixed in terms of distance and orientation in their plane relative to the virtual trunk 54, but pivot jointly with the virtual head 50 around the axis A-A′.

The positioning module of the virtual trunk 54 and virtual shoulders 58 is further able to define, in real time, the position of the ends 60 of the virtual shoulders 58, here shown by spheres, which serve as a base for the construction of the virtual limbs 59 of the avatar 38, as will be seen below.

The position of the ends 60 is defined by a predetermined distance d1 between the ends 60 and the trunk 54, for example approximately 20 cm (average head-shoulder distance).

The positioning module of the virtual limbs 59 is able to receive the data from the second sensor 20 to determine the position and orientation of part of each limb of the user 14, 16 in the real world.

In this example, the part of the limb of the user 14, 16 detected by the second sensor 20 comprises the user's hand, and at least the beginning of the forearm.

The positioning module of the virtual limbs 59 is able to process the data from the second sensor 20 to recalibrate the position data from the second sensor 20 from the reference system of the second sensor 20 to the shared reference system, based in particular on the fixed position of the second sensor 20 on the retrieval assembly 24 and on the data from the position sensor 17 and the first sensor 18.

The positioning module of the virtual limbs 59 is able to create and position an oriented virtual representation of the part of the limb of the user 14, 16 detected by the second sensor 20, here a virtual hand 62 on the avatar 38.

The positioning module of the virtual limbs 59 is also able to determine the orientation and the position of the second region 66 of each virtual limb based on data received from the second sensor 20. In this example, the second region 66 of the virtual limb is the forearm.

To that end, the positioning module of the virtual limbs 59 is able to determine the orientation of the beginning of the forearm of the user 14, 16 in the real world, based on data from the sensor 20, and to use that orientation to orient the second region 66 of each virtual limb 59 from the position of the virtual hand 62, the orientation of the beginning of the forearm and a predefined distance d2 defining the length of the second region 66 between the virtual hand 62 and a virtual elbow 68, for example approximately 30 cm (average length of the forearm).

Then, once the position of the virtual elbow 68 is known, the positioning module of the virtual limbs 59 is able to determine the position and orientation of the first region 64 of each virtual limb between the ends 60 of the virtual shoulder 58, in particular obtained from data from the first sensor 18, as described above, and the virtual elbow 68.

The positioning module is further suitable for determining whether the position of the virtual hand 62, as obtained from the sensor 20, is physiologically possible. This determination is for example done by determining the distance d3 separating the end 60 of the virtual shoulder 58 from the virtual elbow 68 and comparing it with a maximum possible physiological value, for example equal to 45 cm.

Thus, for each user 14, 16, the characteristics and positioning of an avatar 38 corresponding to the user 14, 16 are created and defined by the creation and positioning application 36.

The avatar 38 follows the general orientations of the head and hands of the user 14, 16. The avatar 38 also has animated virtual limbs 59, the orientations of which are close, but not identical, to those of the real limbs of the user 14, 16 in the real world, which simplifies the operation of the system 10, while offering a perception representative of the real movements of the limbs.

The definition and position information of each avatar 38 is defined and/or transposed in the shared reference system and shared within the computing unit 22.

Each avatar 38 can thus be positioned and oriented in real time in the virtual environment 12.

The control and retrieval application 40 of the virtual environment 12 and the avatars 38 is able to process the data created by the creation and positioning application 36 to retrieve a virtual three-dimensional representation representative of the virtual environment 12 and at least one avatar 38 present in that virtual environment 12 in each retrieval assembly 24.

On this basis, the application 40 is able to create a virtual three-dimensional representation specific to each user 14, 16, which depends on the position of the user 14, 16 in the virtual environment 12, and the viewing direction of the user 14, 16.

The virtual three-dimensional representation specific to each user 14, 16 is able to be transmitted in real time to the retrieval assembly 24 of the relevant user 14, 16.

To that end, the application 40 includes, for each user 14, 16, a control and display module of the virtual environment 12 and the selective display of one or several avatars 38 of other users 14, 16 in that virtual environment 12, and a module for partially concealing the avatar 38 of the user 14, 16 and/or of other users 14, 16.

Advantageously, the application 40 further includes a module for displaying and/or selecting virtual objects in the environment from the avatar 38 of the user 14, 16.

The control and retrieval application 40 is for example driven and configured solely by the second user 16.

The control module of the display is able to process the obtained data centrally in the computing unit 22 in real time to display, in the retrieval assembly 24 associated with a given user 14, 16, a virtual three-dimensional representation of the virtual environment 12, taken at the position of the user 14, 16, along the viewing direction of the user, as determined by the position sensors 17 and by the first sensor 18.

The control module of the display is further able to display, in the virtual three-dimensional representation, the avatars 38 of one or several users 14, 16, based on preferences provided by the second user 16.

In one operating mode, the control module of the display is able to display, for each user 14, all of the avatars 38 of other users 14, 16 present in the virtual environment 12.

In another operating mode, the control module of the display is able to keep the avatar 38 of at least one user 14, 16 hidden.

Thus, the second user 16 is able to configure the control module of the display to receive, in his retrieval assembly 24, only the avatar 38 of a selected user 14, without seeing the avatars of the other users 14.

This for example makes it possible to isolate one or several users 14, and to exclude the other users 14, who advantageously receive a message telling them that they are temporarily excluded from the simulation.

Likewise, the second user 16 is able to command the control module of the display to prevent each first user 14 from seeing the avatars 38 of the other users 14 in their respective retrieval assemblies, while retaining the possibility of observing all of the users 14 in his own retrieval assembly 24.

This makes it possible to group together a large number of users in a same confined location in the virtual environment 12, while preventing the users from being bothered by the avatars 38 of other users 14, 16. This is particularly advantageous relative to a real environment, which could not receive all of the users 14, 16 in a confined location.

The partial concealing module is able to hide the upper part of the specific avatar 38 of the user 14, 16 in the virtual three-dimensional representation created by the retrieval assembly 24 of that user 14, 16. Thus, the virtual head 50, the virtual shoulders 58 and the virtual neck 56 of the specific avatar 38 of the user 14, 16 are hidden in his retrieval assembly 24 so as not to create unpleasant sensations due to the different positioning between the virtual shoulders 58 and the real shoulders.

The partial concealing module is further able to hide the virtual limbs 59 of at least one user 14, 16, in the absence of data detected by the second sensors 20 of that user 14, 16, and/or if that data produces virtual hand 62 positions that are not physiologically possible, as described above.

The module for displaying and/or selecting virtual objects is able to allow the display of a command menu, in a predefined position of at least part of the limb of the user 14, 16 relative to the head of the user 14, 16.

The predefined position is for example a particular orientation of the palm of the hand of the user 14, 16 relative to his head, in particular when the palm of the hand faces the head.

To that end, the module for displaying and/or selecting virtual objects is able to determine the angle between a vector perpendicular to the palm of the hand, obtained from the second sensor 20, and a second vector extending between the hand and the head.

If this angle is below a given value, for example 80°, which happens when the palm of the hand comes closer to the head to face the head (see FIG. 5), the module for displaying and/or selecting virtual objects is able to display a selection menu 90 in the virtual environment 12, opposite the head of the user 14, 16.

The module for displaying and/or selecting virtual objects is able to close the selection menu 90 if the aforementioned angle increases beyond the predefined value, for a predefined length of time, for example longer than one second.

The module for displaying and/or selecting virtual objects is able to allow the choice of a function 92 from the selection menu 90, by moving a finger of the virtual hand 62 of the avatar 38 over a selected zone of the displayed selection menu 90.

In one alternative, the module for displaying and/or selecting virtual objects is able to allow the selection of a function 92 from the displayed selection menu by ray tracing. Ray tracing consists of maintaining the viewing direction in the retrieval assembly 24 to target the function 92 to be selected for a predefined length of time.

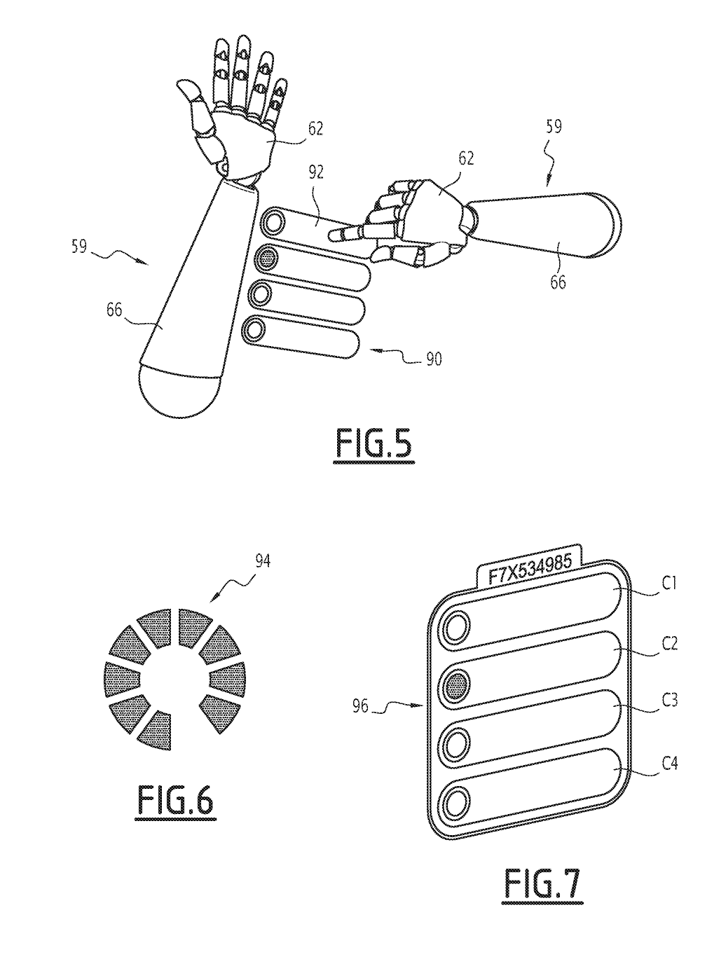

If the viewing direction, as detected by the first sensor 18, targets the zone corresponding to the function 92 for a length of time longer than a predetermined time, the module for displaying and/or selecting virtual objects is able to select that function. Advantageously, it is able to display a counter 94, visible in FIG. 6, representative of the sight time necessary to activate the selection.

The module for displaying and/or selecting virtual object is also able to show information corresponding to an element present in the virtual environment 12, for example a part of the aircraft, when that part is selected either by sight, as previously described, or by virtual contact between the virtual hand 62 of the user's avatar 38 and the part.

In the example shown in FIG. 7, the module for displaying and/or selecting virtual objects is able to show a pop-up menu 96 designating the part and a certain number of possible choices C1 to C4 for the user, such as hiding the part (C1), isolating the part (C2), enlarging the part (C3), or canceling the selection (C4).

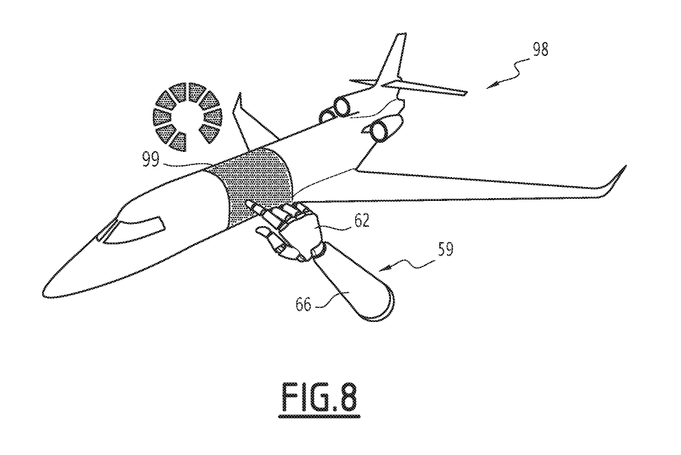

In the alternative illustrated in FIG. 8, the user 16 is able to show a reduced-scale model 98 of the platform to select a zone 99 of that platform intended to be used as virtual environment 12. The selection is made as before, by virtual contact between the virtual hand 62 of the user's avatar 38 and the model 98 and/or by sight.

Once the selection is made, the virtual environment 12 is modified to show the selected zone 99.

A method for developing and carrying out a virtual three-dimensional simulation shared between several users 14, 16 will now be described.

Initially, the virtual simulation system 10 is activated. Each user 14, 16 equips himself with a retrieval assembly 24 provided with a position sensor 17, a first sensor 18 for detecting a viewing direction of the user 14, 16, and a second sensor 20 for detecting the position of part of a limb of the user 14, 16.

The computing unit 22 recovers the data, via the application 34, regarding the virtual environment 12 in which the users 14, 16 are intended to be virtually immersed. This data for example comes from a digital model of the platform or the region of the platform in which the users 14, 16 will be immersed. The application 35 generates a virtual three-dimensional representation of the virtual environment 12.

The computing unit 22 then collects, in real time, the data from each sensor 17, 18, 20 to create and position an avatar 38 corresponding to each user 14, 16 in the virtual environment 12.

To that end, for each user 14, 16, the application 36 transposes the data from the second sensor 20 to place it in the reference system associated with the first sensor 18, then transposes the obtained data again, as well as the data from the first sensor 18, into a reference system of the virtual environment 12, shared by all of the users.

The positioning module of the virtual head 60 uses the data from the position sensor 17 and the data from the first sensor 18 to orient the virtual head 50 of the avatar 38 and the marker 52 representative of the viewing direction.

The positioning module of the virtual trunk 54 and the virtual shoulders 58 next determine the position and orientation of the virtual trunk 54, and sets the orientation of the virtual shoulders 58, in a vertical plane whereof the orientation pivots jointly with the viewing direction around a vertical axis A-A′ passing through the virtual head 60. It next determines the position of each end 60 of a virtual shoulder, as defined above.

At the same time, the positioning module of the virtual limbs 59 determines the position and orientation of the hands and forearm of the user 14, 16, from the second sensor 20.

The positioning module of the virtual limbs 59 then determines the position and orientation of the virtual hand 62 and the second region 66 of the virtual limb, up to the elbow 68 situated at a predefined distance from the virtual hand 62. It then determines the position of the first region 64 of the virtual limb 59 by linearly connecting the end 60 of the virtual shoulder 58 to the elbow 68.

At each moment, the position and orientation of each part of the avatar 38 corresponding to each user 14, 16 is therefore obtained by the central unit 22 in a reference system shared by each of the users 14, 16.

Then, depending on the preferences selected by the second user 16, the control module of the display of the retrieval application 40 provides the retrieval assembly 24 of at least one user 14, 16 with a three-dimensional representation of the virtual environment 12, and the avatar(s) 38 of one or more other users 14, 16.

The concealing module hides the upper part of the specific avatar 38 of the user 14, 16, as previously described, in particular the virtual head 50, and the virtual shoulders 58 to avoid interfering with the vision of the user 14, 16.

Furthermore, the concealing module detects the physiologically impossible positions of the virtual hand 62 of each user 14, 16, basing itself on the calculated length of the first region 64 of the virtual limbs 59, as previously described.

When physiologically impossible positions are detected, the display of the corresponding virtual limb 59 is hidden.

Owing to the system 10, the users 14, 16 can move in the same virtual environment 12 while been shown in the form of an animated avatar 38.

Each user 14, 16 is able to observe the avatars of the other users 14, 16 that are correctly localized in the virtual environment 12.

The provision of animated avatars 38, based on orientation data of the user's head and the real position of part of the user's limbs also makes it possible to follow the gestures of each of the users 14, 16 in the virtual environment 12 through their respective avatars 38.

This therefore makes it possible to organize a meeting between several users 14, 16, in a virtual environment 12, without the users 14, 16 necessarily being located in the same place.

Furthermore, the animated avatars 38 allow at least one user 16 to follow the position and gestures of another user 14 or a plurality of users 14 at the same time.

Thus, the users 14 can simultaneously or individually simulate maintenance and/or usage operations of a platform and at least one user 16 is able to monitor the performed operations.

The selection, for each user 14, 16, of the avatar(s) 38 that the user 14, 16 can see increases the functionalities of the system 10. It is thus possible for a user 16 to follow and evaluate the movements of other users 14 simultaneously, while allowing the users 14 to designate equipment or circuits on the platform, without each user 14 being able to see the movements of the other users 14.

The system 10 is further advantageously equipped with means making it possible to show information and/or selection windows in the virtual three-dimensional environment 12, and to select functions within these windows directly in the virtual environment 12.

Furthermore, the system 10 and the associated method make it possible to place a plurality of users 14 in a same confined region, whereas in reality, such a region would be too small to accommodate all of the users 14, 16.

The perception of the other users 14, 16 via the animated avatars 38 is particularly rich, since each user 14, 16 can selectively observe the general direction of the head of each other user 14, 16, as well as the position of the hands and a globally close representation of the position of the limbs of the user 14, 16.

In one alternative, the system 10 includes a system for recording the movements of the avatar(s) 38 in the virtual environment 12 over time, and a playback system, either immersive or on a screen, for the recorded data.

In another alternative, the second user 16 is not represented by an avatar 38 in the virtual environment 12. He then does not necessarily wear a first sensor 18 or second sensor 20.

In one alternative, the control and retrieval application 40 is able to vary the transparency level of each avatar 38 situated at a distance from a given user 14, 16, based on the distance separating that avatar 38 from the avatar 38 of the given user in the virtual environment 12. For example, if the avatar 18 of another user 14, 16 approaches the avatar 18 of the given user, the transparency level increases, until the avatar 18 of the other user 14, 16 becomes completely transparent when the distance between the avatars is below a defined distance, for example comprised between 10 cm and 15 cm.

Conversely, the transparency level decreases when the avatars 18 move away from each other.

The transposition, for each user, of the data from the second sensor 20 to place it in the reference system associated with the first sensor 18, then the transposition of the obtained data, as well as the data from the first sensor 18, into a reference system of the virtual environment 12, shared by all of the users, simplifies the computer processing of the data by creating, for each user, a consistent set of data that is easier for the computing unit 22 to process. Thus, the creation and positioning application 36 works more coherently.

What is claimed is:

1. A three-dimensional simulation system for generating a virtual environment involving a plurality of users, comprising:
for at least one first user, a first detection sensor detecting a viewing direction of the at least one first user;
a computer configured to create a three-dimensional simulation of the virtual environment, based on data received from the first detection sensor of the at least one first user;
for at least one second user, an immersive retriever for the virtual three-dimensional simulation created by the computer, configured to immerse the at least one second user in the virtual three-dimensional simulation; and
for the at least one first user, a second detection sensor detecting the position of part of an actual limb of the at least one first user,
the computer being configured to create, in the virtual three-dimensional simulation, an avatar of the at least one first user, comprising at least one virtual head and at least one virtual limb, reconstituted and oriented relative to one another based on data from the first detection sensor and the second detection sensor of the at least one first user.

2. The system according to claim 1, wherein the limb and the virtual limb are arms of the at least one first user and of the avatar of the at least one first user, respectively.

3. The system according to claim 2, wherein the part of the at least one first user's limb detected by the second detection sensor comprises at least one first user's hand.

4. The system according to claim 1, wherein the computer is configured to determine the position of a first region of the virtual limb, based on data received from the first detection sensor, and is configured to determine the position of a second region of the virtual limb from data received from the second detection sensor.

5. The system according to claim 4, wherein the computer is configured to determine the position of the first region of the virtual limb after having determined the position of the second region of the virtual limb.

6. The system according to claim 4, wherein the limb and the virtual limb are arms of the at least one first user and of the avatar of the at least one first user, respectively, and wherein the computer is configured to create a representation of a virtual shoulder of the at least one first user, rotatable around a vertical axis jointly with the virtual head of the at least one first user, the first region of the virtual limb extending from the end of the virtual shoulder.

7. The system according to claim 1, comprising, for each first user of a plurality of first users, a first detection sensor for detecting a viewing direction of the first user, and a second detection sensor for detecting the position of part of a limb of the first user,
the computer being configured to create, in the virtual three-dimensional simulation, an avatar of each first user, comprising at least one virtual head and at least one virtual limb, reconstituted and oriented relative to one another based on data from the first detection sensor and the second detection sensor of the first user,
the at least one immersive retriever being configured to selectively show the avatar of one or several first users in the virtual three-dimensional simulation.

8. The system according to claim 7, wherein the computer is configured to place the avatars of a plurality of first users in a same given location in the virtual three-dimensional simulation, the at least one immersive retriever being configured to selectively show the avatar of a single first user in the given location.

9. The system according to claim 7, wherein the computer is configured to transpose the data from the second detection sensor, produced in a reference system specific to the second detection sensor, to place the data in a reference system associated with the first detection sensor, then to transpose the transposed data again, as well as the data from the first detection sensor, into a reference system of the first detection sensor, in a reference system of the virtual environment, shared by all of the users.

10. The system according to claim 1, comprising, for the at least one first user, an immersive retriever for the virtual three-dimensional simulation created by the unit, configured to immerse the at least one first user in the virtual three-dimensional simulation.

11. The system according to claim 10, wherein the immersive retriever is configured to be supported by the head of the at least one first user, the first detection sensor and/or the second detection sensor being mounted on the immersive retriever.

12. The system according to claim 10, wherein, in a given predefined position of the part of a limb of the at least one first user detected by the second detection sensor, the computer is configured to display at least one information and/or selection window in the virtual three-dimensional simulation visible by the at least one first user and/or by the at least one second user.

13. The system according to claim 1, wherein the computer is configured to determine whether the position of the part of the real limb of the first user detected by the second detection sensor is physiologically possible and to conceal the display of the virtual limb of the avatar of the at least one first user if the position of the part of the real limb of the at least one first user detected by the second detection sensor is not physiologically possible.

14. The system according to claim 1, comprising, for the at least one first user, a position detection sensor, configured to provide the computer with geographical positioning data for the at least one first user.

15. A method for developing a virtual three-dimensional simulation bringing several users together comprising:
providing the system according to claim 1;
activating the first detection sensor and the second detection sensor of the at least one first user and transmitting data received from the first detection sensor and the second detection sensor of the at least one first user to the computer; and
generating a virtual three-dimensional simulation, an avatar of the at least one first user, comprising at least one virtual head and at least one virtual limb, reconstituted and oriented relative to one another based on data from the first detection sensor and the second detection sensor of the at least one first user.

16. The method according to claim 15, wherein the generation of the virtual three-dimensional simulation comprises loading a model representative of the platform, and the virtual three-dimensional representation of the virtual environment of a region of the platform, the at least one first user moving in the aircraft environment to perform at least one simulated maintenance and/or usage operation of the platform.
